(19) United States
(12) Patent Application Publication
(10) Pub. No.: US 2011/0320578 A1
(43) Pub. Date: Dec. 29, 2011

(54) Operations support system with modular architecture

(75) Inventor: Rahim Pirbhai, Ottawa (CA)

(73) Assignee: Alcatel-Lucent Canada Inc.

(21) Appl. No.: 12/803,516

(22) Filed: Jun. 29, 2010

(51) Int. Cl. G06F 15/173

(52) U.S. Cl. 709/223

(57) ABSTRACT

An operations support system comprises a plurality of functionality handler modules each provide a respective operations support functionality. Each one of the functionality handler modules is an independent system architecture module with respect to each other one of the functionality handler modules thereby allowing each one of the functionality handler modules to be selectively enabled and disabled with respect to each other one of the functionality handler modules. One or more communication clients are configured for supporting communication between the operations support system and a network node management system. One or more handler interfaces are configured for supporting communication between each one of the functionality handler modules and the one or more communication client.

### FIELD OF THE DISCLOSURE

The disclosures made herein relate generally to systems, methods and computer-readable medium configured for providing operations support functionality and, more particularly, to operations support systems, methods, and computer-readable medium for use in telecommunication networks.

### BACKGROUND

An operations support system (also referred to as OSS or operational support system) performs a variety of functions for telecommunications service providers and their networks. Examples of such functions include, but are not limited to, functions related to system management, functions related to perssonnel management, functions related to inventory, functions related to engineering, functions related to planning, and functions related to repair/maintenance. Accordingly, an operations support system is used by a communications service provider to monitor, control, analyze and manage a telecommunication (e.g., telephone and/or computer) network.

As shown in FIG. 1, known operations support systems (i.e., the prior art operations support system 10) have a monolithic architecture. In an operations support system having such a monolithic architecture, various adapters or plug-ins (e.g., interface adapters 12, 14, 16) are provided for interfacing with different vendors' equipment (e.g., functionality apparatuses 18, 20, 22). This monolithic architecture can require that, when new functionality is to be added via a new adapter or plug-in, the adapter or entire operations support system to be recompiled. Altering the operations support system through such recompiling, for example, is risky in that existing functionality can be broken or otherwise adversely affected.

### SUMMARY OF THE DISCLOSURE

Embodiments of the present invention relate to a modular architecture for an operations support system (i.e., a modular operations support system). More specifically, embodiments of the present invention use a plurality of discrete functionality handler modules to provide required functionality for the operations support system. Each one of the functionality handler modules communicates independently with a compatible handler interface and corresponding communication client of the modular operations support system to carry out its respective operations support functionality. New operations support functionality is added to the modular operations support system by creating an functionality handler module with a program that provides the new operations support functionality thereby allowing new operations support functionality to be added with less work and reduced risk to existing functionality.

In one embodiment of the present invention, an operations support system comprises a plurality of functionality handler modules, one or more communication clients, and one or more handler interfaces. The plurality of functionality handler modules each provide a respective operations support functionality. Each one of the functionality handler modules is an independent system architecture module with respect to each other one of the functionality handler modules thereby allowing each one of the functionality handler modules to be selectively enabled and disabled with respect to each other one of the functionality handler modules. The one or more communication clients are configured for supporting communication between the operations support system and a network node management system. The one or more handler interfaces are configured for supporting communication between each one of the functionality handler modules and the one or more communication client.

In another embodiment of the present invention, a method for providing operations support functionality in an operations support system comprises a plurality of operations. An operation is performed for coupling a plurality of functionality handler modules to a corresponding one of a plurality of handler interfaces. The corresponding one of the handler interfaces is coupled to a corresponding one of a plurality of communication clients. The corresponding one of the handler interfaces and the corresponding one of the communication clients can communicate in accordance with a common communication protocol or can communicate independent of a common communication protocol. Each one of the functionality handler modules provides a respective operations support functionality. An operation is performed by the corresponding one of the handler interfaces for communicating operations functionality information between one or more of the functionality handler modules and the corresponding one of the communication clients. An operation is performed by the corresponding one of the communication clients for communicating the operation functionality information between the operations support system and a system to which the operations support system is coupled.

In another embodiment of the present invention, a telecommunication network apparatus comprises a plurality of functionality handler modules, a plurality of handler interfaces, and a plurality of communication clients. The plurality of functionality handler modules are coupled with a corresponding one of a plurality of handler interfaces. The corresponding one of the handler interfaces is coupled to a corresponding one of a plurality of communication clients. The corresponding one of the handler interfaces and the corresponding one of the communication clients can communicate in accordance with a common communication protocol or can communicate independent of a common communication protocol. Each one of the functionality handler modules provides a respective operations support functionality. The corresponding one of the handler interfaces provide for communication of operations functionality information between one or more of the functionality handler modules and the corresponding one of the communication clients. The corresponding one of the communication clients provides for communication of the operations functionality information between the operations support system and a system to which the operations support system is coupled.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 shows a prior art embodiment of a monolithic operations support system.

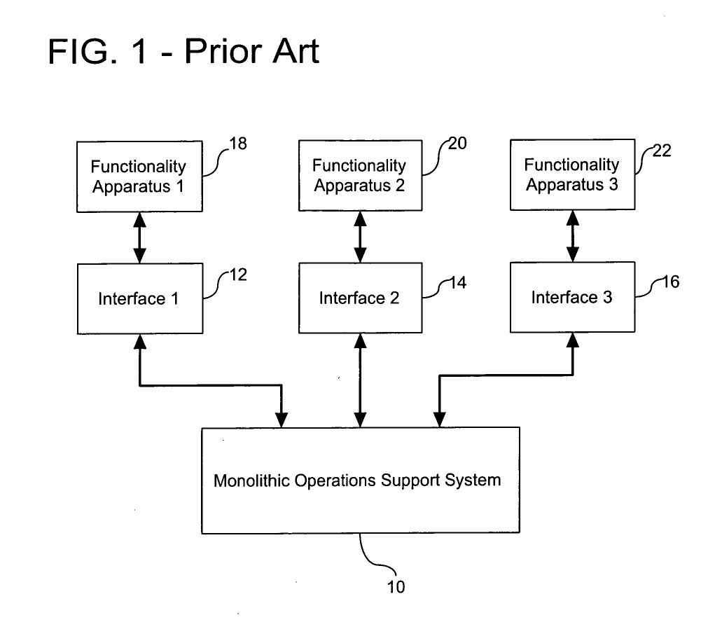

FIG. 2 shows a modular operations support system configured in accordance with an embodiment of the present invention.

### DETAILED DESCRIPTION OF THE DRAWING FIGURES

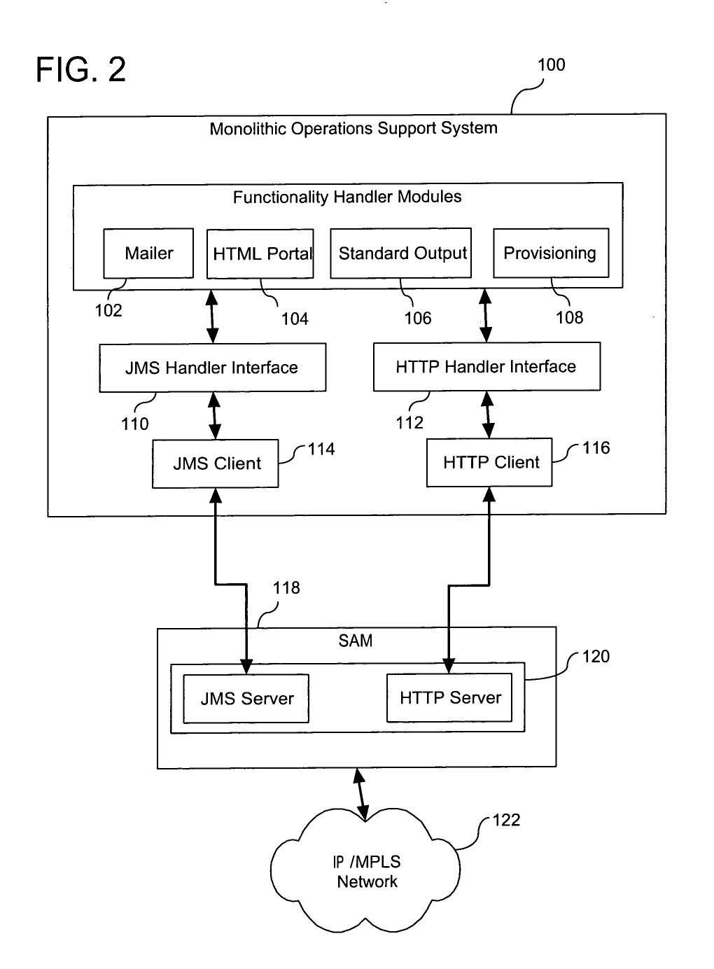

Referring now to FIG. 2, a modular operations support system 100 configured in accordance with an embodiment of the present invention is shown. The modular operations support system 100 includes a plurality of discrete functionality handler modules that provide required functionality for the operations support system 100. In view of the disclosures made herein, a skilled person will appreciate that the intention of the modular operations support system 100 is to allow an end-customer to seamlessly plug-in one or more discrete functionality handler modules to perform custom-handling of data to and from an operations interface of a network apparatus such as, for example, a Service Aware Manager (SAM).

As shown, examples of the functionality handler modules include, but are not limited to, a mailer functionality handler module 102, a HTML portal functionality handler module 104, a standard functionality handler module 106, and a provisioning functionality handler module 108. The mailer functionality handler module 102 can, for example, be provided to receive notification of subscribed alarms types and to perform some processing on the alarm notification and e-mail the processed notification to various operations support personnel. For example, alarms relating to certain services could be e-mailed to one group of operating system personnel and alarms relating to certain equipment could be e-mailed to another. Furthermore, the mailer could retrieve provisioning information on the managed network nodes that relates to the alarm notifications. The HTML portal functionality handler module 104 can provides a user interface (e.g., graphical user interface (GUI)). The standard output functionality handler module 106 can provide textual information of subscribed events directly to a console. The provisioning functionality handler module 108 can provide for accessing and changing provisioning information on the managed network nodes. It is disclosed herein that a modular operations support system is not unnecessarily limited to any particular quantity of functionality handler modules or type of functionality provided by such functionality handler modules. It is also disclosed herein that the respective operations support functionality of each one of the operation functionality handler modules can be different than the respective operations support functionality of each other one of the operation functionality handler modules.

The modular operations support system 100 can include, but is not limited to including, a JAVA message Service (JMS) handler interface 110, a HTTP handler interface 112, a JMS client 114, and a HTTP client 116. The JMS client 114 and the HTTP client 116 each provide for communication with a remote network apparatus such as a SAM 118 via a respective portion (e.g., JMS portion or HTTP portion) of an operations interface 120 of the SAM 118. The JMS client 114 and the HTTP client 116 (i.e., operations support system clients) are each standalone system entities that interface with the SAM 118 via the SAM interface 120 for supporting data transmission to and from SAM-O, are intelligent enough to manage communications with the SAM 118, and that are configured for effectively and gracefully recovering from communication failures. The SAM 118 can be a network and service management system configured for managing one or more network nodes (e.g., the IP/MPLS network node 122). In one embodiment, the JMS portion of the SAM 118 is a JMS server that provides for real-time messaging of events occurring on the managed network nodes on a subscription basis (e.g., notification of events such as alarms that are subscribed to are delivered to a subscribing client by the JMS server) and the HTTP portion of the SAM 118 is a HTTP server that is configured for inquiring of the SAM about past events or provisioning on the managed network nodes.

An Alcatel-Lucent 5620 Service Aware Manager is one specific example of the SAM 118. The Alcatel-lucent 5620 SAM enables unified, end-to-end management of Internet Protocol (IP)/multi-protocol label switching (MPLS) and Carrier Ethernet networks and the services they deliver. Furthermore, an operations interface of the Alcatel-Lucent 5620 SAM provides an XML interface for operations support system applications to interact therewith. Each operations support system application can exchange data with Alcatel-Lucent 5620 SAM via JMS channels to receive real-time network event information from the Alcatel-Lucent 5620 SAM server and/or via request-response driven communication using HTTP.

Each one of the functionality handler modules 102, 104, 106, 108 communicates independently with a compatible one of the handler interfaces 110, 112 for carrying out its respective operations support functionality. As such, the functionality handler modules 102, 104, 106, 108 are each standalone entities of the modular operations support system 100 that process (i.e., “handles”) data originating-from and destined-to the operations interface of the SAM 118. Thus, a skilled person will appreciate that a functionality handler module configured in accordance with the present invention preferably provides data communication functionality that includes interfacing with higher-level entities (e.g., the end-user), interfacing with the operations support system client(s) of the modular operations support system via a corresponding handler interface, and being configured for implementing a corresponding handler interface in order to allow successful two-way communication with a compatible operations support system client (e.g., the JMS client 114, the HTTP client 116, etc). Similarly, a skilled person will also appreciate that a first operation functionality handler module, a first handler interface and a first communication client of a modular operations support system configured in accordance with the present invention can all be configured for communicating in accordance with a first communication protocol and that a second operation functionality handler module, a second handler interface and a second communication client of such modular operations support system can all be configured for communicating in accordance with a second communication protocol. In view of the disclosures made herein, a skilled person will appreciate that a single functionality handler module can communicate with a single handler interface (1:1), a single functionality handler module can communicate with multiple handler interfaces (1:N), a plurality of functionality handler modules can communicate with a single handler interface (N:1), and a plurality of functionality handler modules can communicate with a corresponding plurality of handler interfaces (i.e., M:N). To this end, a handler interface configured in accordance with the present invention can be configured independent of a particular communication protocol such that there can be a 1:1, 1:N, N:1 or M:N coupling of handler interfaces to communication clients of an operation support system.

Each one of the operations functionality handler modules 102, 104, 106, 108 is an independent system architecture module with respect to each other one of the operations functionality handler modules. In this manner, each one of the operations functionality handler modules 102, 104, 106, 108 can be selectively enabled and disabled with respect to each other one of the operations functionality handler modules. For example, a particular one of the operations functionality handler modules 102, 104, 106, 108 can be individually and selectively installed/removed, activated/deactivated, removed/replaced, etc. When required, new operations support functionality can be added to the modular operations support system 100 by creating a functionality handler module with a program that provides the new operations support functionality (i.e., a new functionality handler module). In this manner, new operations support functionality can be added to the modular operations support system 100 with ease and with reduced risk to existing functionality (i.e., functionality being provided by other functionality handler modules).

The JMS handler interface 110 and the HTTP handler interface 112 are each configured for independently supporting communication between one or more of the operations functionality handler modules 102, 104, 106, 108 and a corresponding one of the communication clients 114, 116. The JMS handler interface 110 and JMS client 114 are static in the sense that they are not changed as new functionality is added to the modular operations support system 100 via a new functionality handling module. Similarly, the HTTP handler interface 112 and HTTP client 116 are also static in this manner. Accordingly, handler interfaces and their respective communication clients jointly support communication between all of the operations functionality handler modules and the network node management system irrespective of a particular type of operations functionality provided by each one of the operations functionality handler modules.

Referring now to instructions processible by a data processing device, it will be understood from the disclosures made herein that methods, processes and/or operations adapted for carrying out operations support functionality as disclosed herein are tangibly embodied by computer readable medium having instructions thereon that are configured for carrying out such functionality. In one specific embodiment, the instructions are tangibly embodied for carrying out the method 100 disclosed above. The instructions may be accessible by one or more data processing devices from a memory apparatus (e.g. RAM, ROM, virtual memory, hard drive memory, etc), from an apparatus readable by a drive unit of a data processing system (e.g., a diskette, a compact disk, a tape cartridge, etc) or both. Accordingly, embodiments of computer readable medium in accordance with the presenting invention include a compact disk, a hard drive, RAM or other type of storage apparatus that has imaged thereon a computer program (i.e., instructions) adapted for carrying out operations support functionality in accordance with the present invention.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An operations support system, comprising:
a plurality of functionality handler modules each providing a respective operations support functionality, wherein each one of said functionality handler modules is an independent system architecture module with respect to each other one of said functionality handler modules thereby allowing each one of said functionality handler modules to be selectively enabled and disabled with respect to each other one of said functionality handler modules;
at least one communication client configured for supporting communication between the operations support system and a network node management system; and
at least one handler interface configured for supporting communication between each one of said functionality handler modules and said at least one communication client.

2. The operations support system of claim 1 wherein each one of said functionality handler modules, said at least one communication client, and said at least one handler interface are configured for communicating in accordance with a common communication protocol.

3. The operations support system of claim 1 wherein:
a first one of said functionality handler modules, a first handler interface and a first communication client are all configured for communicating in accordance with a first communication protocol; and
a second one of said functionality handler modules, a second handler interface and a second communication client are all configured for communicating in accordance with a second communication protocol.

4. The operations support system of claim 1 wherein the respective operations support functionality of each one of said functionality handler modules is different than the respective operations support functionality of each other one of said functionality handler modules.

5. The operations support system of claim 1 wherein:
said at least one handler interface and said at least one communication client jointly support communication between all of said functionality handler modules and the network node management system irrespective of a particular type of operations functionality provided by each one of said operations functionality handler modules.

6. The operations support system of claim 5 wherein:
a first one of said functionality handler modules, a first handler interface and a first communication client are all configured for communicating in accordance with a first communication protocol; and
a second one of said functionality handler modules, a second handler interface and a second communication client are all configured for communicating in accordance with a second communication protocol.

7. The operations support system of claim 5 wherein the respective operations support functionality of each one of said functionality handler modules is different than the respective operations support functionality of each other one of said functionality handler modules.

8. A method for providing operations support functionality in an operations support system, comprising:
coupling a plurality of functionality handler modules to a corresponding one of a plurality of handler interfaces, wherein the corresponding one of said handler interfaces is coupled to at least one of a plurality of communication clients, and wherein each one of said functionality handler modules provides a respective operations support functionality;
the corresponding one of said handler interfaces communicating operations functionality information between at least one of said functionality handler modules and said at least one of said communication clients; and
the corresponding one of said communication clients communicating said operations functionality information between the operations support system and a system to which the operations support system is coupled.

9. The method of claim 8 wherein each one of said functionality handler modules is an independent system architecture module with respect to each other one of said functionality handler modules thereby allowing each one of said functionality handler modules to be selectively enabled and disabled with respect to each other one of said functionality handler modules.

10. The method of claim 8 wherein the respective operations support functionality of each one of said functionality handler modules is different than the respective operations support functionality of each other one of said functionality handler modules.

11. The method of claim 8 wherein:
the corresponding one of said handler interfaces and said at least one of said communication clients jointly support communication between all of said functionality handler modules and the system to which the operations support system is coupled irrespective of a particular type of operations functionality provided by each one of said functionality handler modules.

12. The method of claim 11 wherein the respective operations support functionality of each one of said functionality handler modules is different than the respective operations support functionality of each other one of said functionality handler modules.

13. The method of claim 12 wherein each one of said functionality handler modules is an independent system architecture module with respect to each other one of said functionality handler modules thereby allowing each one of said functionality handler modules to be selectively enabled and disabled with respect to each other one of said functionality handler modules.

14. A telecommunication network apparatus, comprising:
a plurality of functionality handler modules coupled with a corresponding one of a plurality of handler interfaces, wherein the corresponding one of said handler interfaces is coupled to at least one of a plurality of communication clients, and wherein each one of said functionality handler modules provides a respective operations support functionality;
the corresponding one of said handler interfaces provide for communication of operations functionality information between at least one of said functionality handler modules and said at least one of said communication clients; and
the corresponding one of said communication clients provide for communication of said operations functionality information between the operations support system and a system to which the operations support system is coupled.

15. The telecommunication network apparatus of claim 14 wherein each one of said functionality handler modules is an independent system architecture module with respect to each other one of said functionality handler modules thereby allowing each one of said functionality handler modules to be selectively enabled and disabled with respect to each other one of said functionality handler modules.

16. The telecommunication network apparatus of claim 14 wherein the respective operations support functionality of each one of said functionality handler modules is different than the respective operations support functionality of each other one of said functionality handler modules.

17. The telecommunication network apparatus of claim 14 wherein:
the corresponding one of said handler interfaces and said at least one of said communication clients jointly support communication between all of said functionality handler modules and the system to which the operations support system is coupled irrespective of a particular type of operations functionality provided by each one of said functionality handler modules.

18. The telecommunication network apparatus of claim 17 wherein the respective operations support functionality of each one of said functionality handler modules is different than the respective operations support functionality of each other one of said functionality handler modules.

19. The telecommunication network apparatus of claim 18 wherein each one of said functionality handler modules is an independent system architecture module with respect to each other one of said functionality handler modules thereby allowing each one of said functionality handler modules to be selectively enabled and disabled with respect to each other one of said functionality handler modules.
